(19) United States
(12) Patent Application Publication
(10) Pub. No.: US 2025/0345948 A1
(43) Pub. Date: Nov. 13, 2025

(54) Grasping Device, Gripper and Terminal Insertion Device

(71) Applicants: TE Connectivity Solutions GmbH, Schaffhausen (CH); Tyco Electronics (Shanghai) Co., Ltd., Shanghai (CN)

(72) Inventors: Xianghao (Jorge) Bao, Shanghai (CN); Liao (Leo) Chen, Shanghai (CN); Senmiao Hu, Shanghai (CN); Dandan (Emily) Zhang, Shanghai (CN); An (Joshua) Yang, Shanghai (CN); Lvhai (Samuel) Hu, Shanghai (CN); Roberto Francisco-Yi Lu, Bellevue, WA (US)

(73) Assignees: TE Connectivity Solutions GmbH, Schaffhausen (CH); Tyco Electronics (Shanghai) Co., Ltd., Shanghai (CN)

(21) Appl. No.: 19/203,744

(22) Filed: May 9, 2025

(30) Foreign Application Priority Data
May 9, 2024 (CN) 202410573754.X

(51) Int. Cl. B25J 15/00; H01R 43/20

(52) U.S. Cl. CPC B25J 15/0033; H01R 43/20

(57) ABSTRACT

A grasping device includes a first gripper for gripping a first component. The first gripper includes a mounting plate formed with a vertical groove extending in a vertical direction and a pair of inclined grooves symmetrically arranged on both sides of the vertical groove. A moving part of the first gripper is slidably engaged with the vertical groove to be able to move along the vertical groove. A pair of first claws of the first gripper are respectively slidably engaged with the pair of inclined grooves to be able to move along the pair of inclined grooves respectively. The pair of inclined grooves form a trumpet shape that flares upwards. The moving part comprises a guide shaft extending in a horizontal direction. Guide holes that are slidably fitted with the guide shaft are respectively formed in the pair of first claws.

### CROSS-REFERENCE TO RELATED APPLICATION

This application claims the benefit of Chinese Patent Application No. CN202410573754.X filed on May 9, 2024 in the State Intellectual Property Office of China, the whole disclosure of which is incorporated herein by reference.

### FIELD OF THE DISCLOSURE

This disclosure relates to a gripper, a grasping device comprising the gripper and a terminal insertion device comprising the grasping device.

### BACKGROUND OF THE INVENTION

In the prior art, when inserting the terminal into the socket of the housing, it is necessary to use a gripper to hold the terminal. The existing gripper typically includes a pair of terminal claws. The pair of terminal claws can move horizontally between closed and open positions to clamp and release the terminal. Therefore, the existing gripper has a horizontal movement mechanism suitable for driving the pair of terminal claws to move horizontally. After the front end of the terminal has been inserted into the socket of the housing, the horizontal moving mechanism drives the pair of terminal claws to open horizontally to release the terminal, so that the terminal can be further inserted into the socket of the housing.

In prior art, after opening the pair of terminal claws, it is necessary to vertically move the pair of terminal claws to a position that does not interfere with the housing, in order to allow the terminal to be further inserted into the socket of the housing. Therefore, the existing gripper also has a vertical movement mechanism suitable for driving the pair of terminal claws to move vertically. This will result in a complex structure of the gripper, requiring a large amount of space and not suitable for applications with limited space.

### SUMMARY OF THE INVENTION

According to an embodiment of the present disclosure, a grasping device includes a first gripper for gripping a first component. The first gripper includes a mounting plate formed with a vertical groove extending in a vertical direction and a pair of inclined grooves symmetrically arranged on both sides of the vertical groove. A moving part of the first gripper is slidably engaged with the vertical groove to be able to move along the vertical groove. A pair of first claws of the first gripper are respectively slidably engaged with the pair of inclined grooves to be able to move along the pair of inclined grooves respectively. The pair of inclined grooves form a trumpet shape that flares upwards. The moving part comprises a guide shaft extending in a horizontal direction. Guide holes that are slidably fitted with the guide shaft are respectively formed in the pair of first claws. When the moving part is moved from bottom to top along the vertical groove, the pair of first claws are driven by the moving part to move obliquely upward along the pair of inclined grooves and move along the guide shaft from a closed state of clamping the first component to an open state of releasing the first component.

### DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 shows an illustrative perspective view of a grasping device according to an exemplary embodiment of the present invention, wherein the first gripper is in a closed state;

FIG. 2 shows an illustrative perspective view of a grasping device according to an exemplary embodiment of the present invention, wherein the first gripper is in an open state;

FIG. 3 shows an illustrative exploded view of a grasping device according to an exemplary embodiment of the present invention, where the first gripper is in a closed state;

FIG. 4 shows an illustrative perspective view of the first gripper of the grasping device according to an exemplary embodiment of the present invention when viewed from the front side, where the first gripper is in a closed state;

FIG. 5 shows an illustrative exploded view of the first gripper of the grasping device according to an exemplary embodiment of the present invention;

FIG. 6 shows an illustrative perspective view of the first gripper of the grasping device according to an exemplary embodiment of the present invention when viewed from the rear, where the first gripper is in a closed state;

FIG. 7 shows a horizontal sectional view of the first gripper of the grasping device according to an exemplary embodiment of the present invention;

FIG. 8 shows an illustrative perspective view of the first gripper of the grasping device according to an exemplary embodiment of the present invention when viewed from the front side, with the first gripper in an open state;

FIG. 9 shows an illustrative plan view of the first gripper of the grasping device according to an exemplary embodiment of the present invention, wherein the first gripper is in a closed state;

FIG. 10 shows a vertical sectional view of the first gripper of the grasping device according to an exemplary embodiment of the present invention, wherein the first gripper is in a closed state;

FIG. 11 shows an illustrative plan view of the first gripper of the grasping device according to an exemplary embodiment of the present invention, wherein the first gripper is in an open state;

FIG. 12 shows a vertical sectional view of the first gripper of the grasping device according to an exemplary embodiment of the present invention, wherein the first gripper is in an open state;

FIG. 13 shows an illustrative perspective view of the second gripper of the grasping device according to an exemplary embodiment of the present invention, wherein the second gripper is in a closed position;

FIG. 14 shows an illustrative exploded view of the second gripper of the grasping device according to an exemplary embodiment of the present invention;

FIG. 15 shows an illustrative view of a terminal insertion device according to an exemplary embodiment of the present invention, where the terminal has not yet been inserted into the socket of the housing;

FIG. 16 shows an illustrative enlarged view of the housing and guide shown in FIG. 15;

FIG. 17 shows an illustrative view of a terminal insertion device according to an exemplary embodiment of the present invention, in which the front end of the terminal has been inserted into the socket of the housing; and

FIG. 18 shows an illustrative view of a terminal insertion device according to an exemplary embodiment of the present invention, wherein the terminal and cable have been inserted into the socket of the housing.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a grasping device comprises a first gripper which is used to grip a first component. The first gripper comprises: a mounting plate which is formed with a vertical groove extending in a vertical direction and a pair of inclined grooves symmetrically arranged on both sides of the vertical groove; a moving part which is slidably engaged with the vertical groove to be able to move along the vertical groove; and a pair of first claws which are respectively slidably engaged with the pair of inclined grooves to be able to move along the pair of inclined grooves respectively. The pair of inclined grooves form a trumpet shape that flared upwards, the moving part comprises a guide shaft extending in a horizontal direction; guide holes that are slidably fitted with the guide shaft are respectively formed in the pair of first claws. When the moving part is moved from bottom to top along the vertical groove, the pair of first claws are driven by the moving part to move obliquely upward along the pair of inclined grooves and move along the guide shaft from a closed state of clamping the first component to an open state of releasing the first component.

According to another embodiment of the present disclosure, a terminal insertion device comprises: the above grasping device, wherein the first gripper and the second gripper are used to respectively grip the terminal and the cable connected to the terminal; and a moving mechanism which is connected to the grasping device and is used to move the grasping device in a predetermined direction to insert the gripped terminal and cable into a socket of a housing.

According to another embodiment of the present disclosure a gripper comprises: a mounting plate which is formed with a vertical groove extending in a vertical direction and a pair of inclined grooves symmetrically arranged at both sides of the vertical groove; a moving part that is slidably engaged with the vertical groove to be able to move along the vertical groove; and a pair of claws which are respectively slidably engaged with the pair of inclined grooves to be able to move along the pair of inclined grooves respectively. The pair of inclined grooves form a trumpet shape that flared upwards, and the moving part comprises a guide shaft extending in a horizontal direction; guide holes that are slidably fitted with the guide shaft are respectively formed in the pair of claws. When the moving part is moved from bottom to top along the vertical groove, the pair of claws are driven by the moving part to move obliquely upward along the pair of inclined grooves and move along the guide shaft from a closed state of clamping the first component to an open state of releasing the first component.

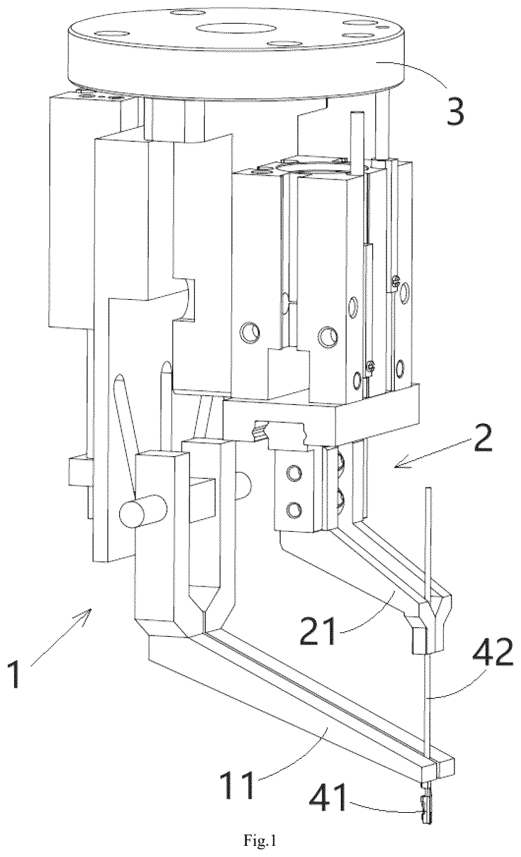

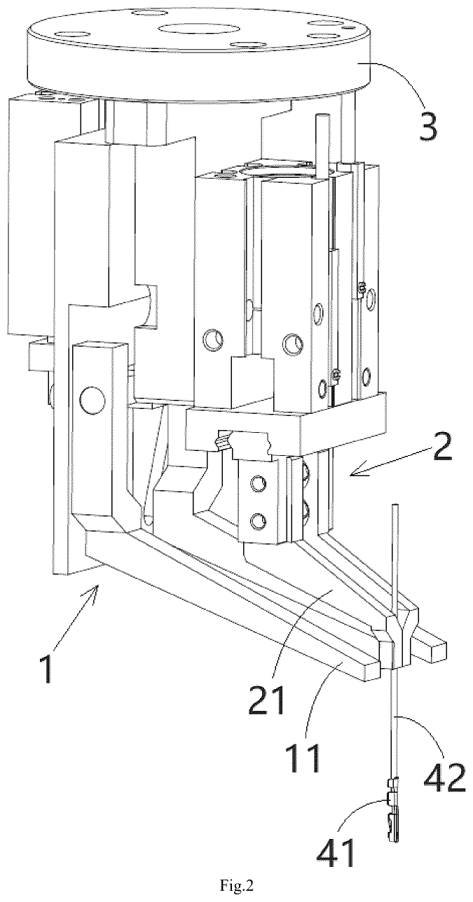

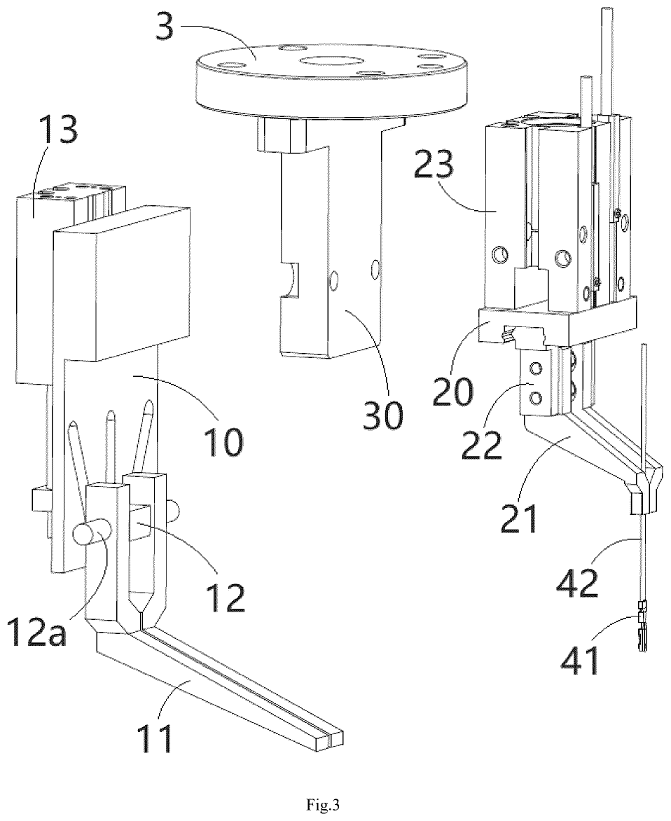

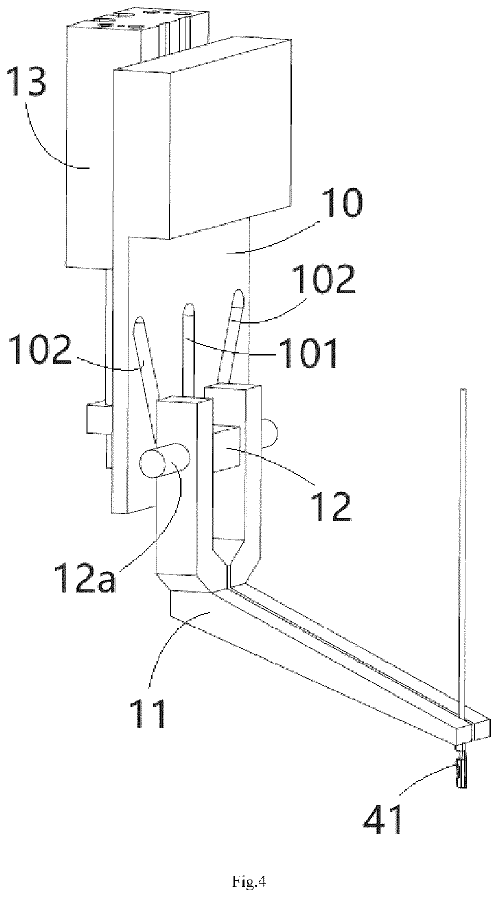

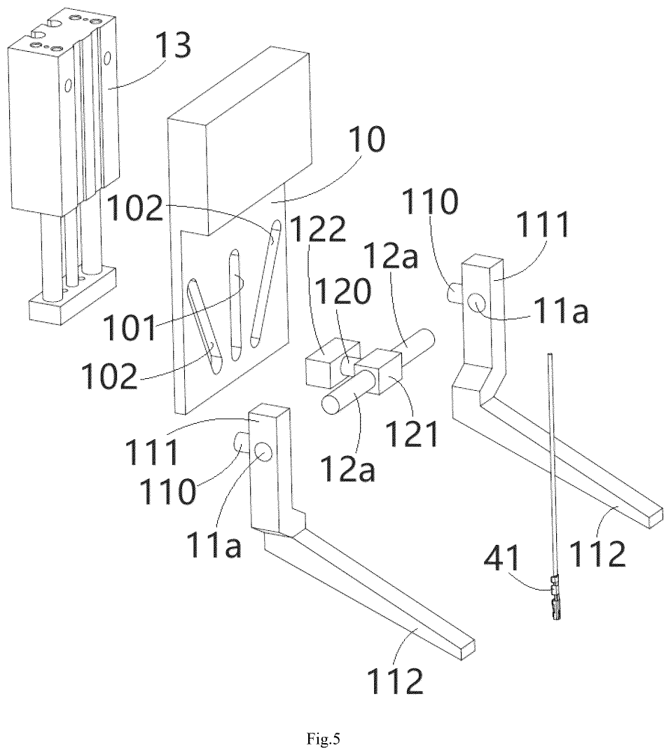

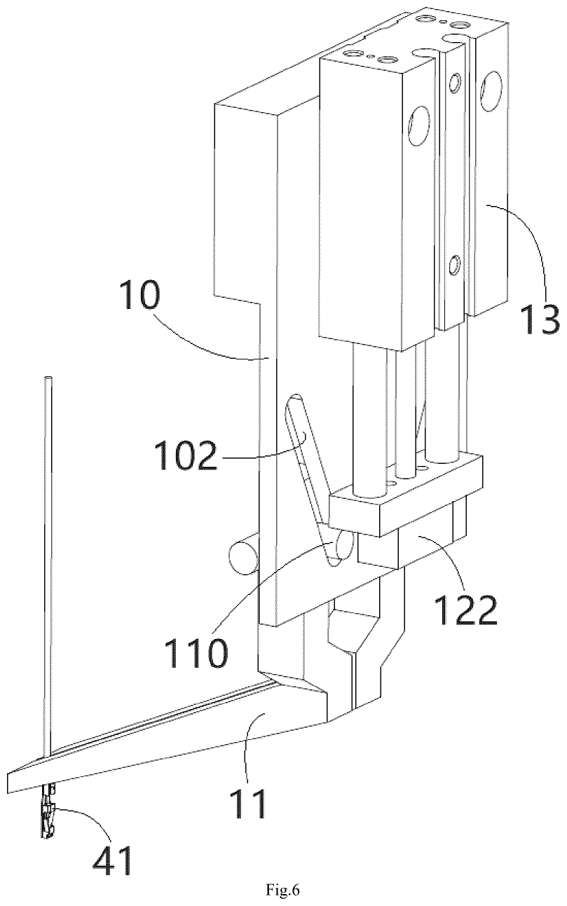

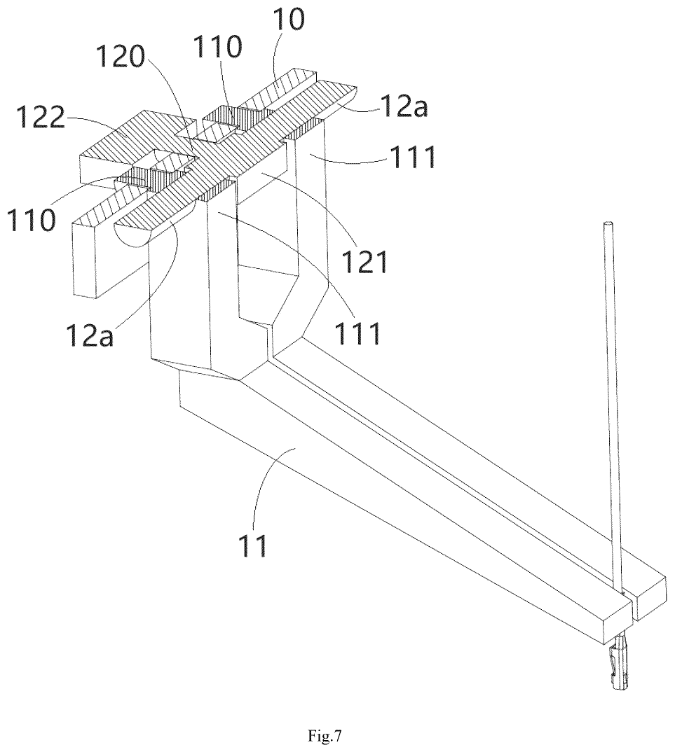

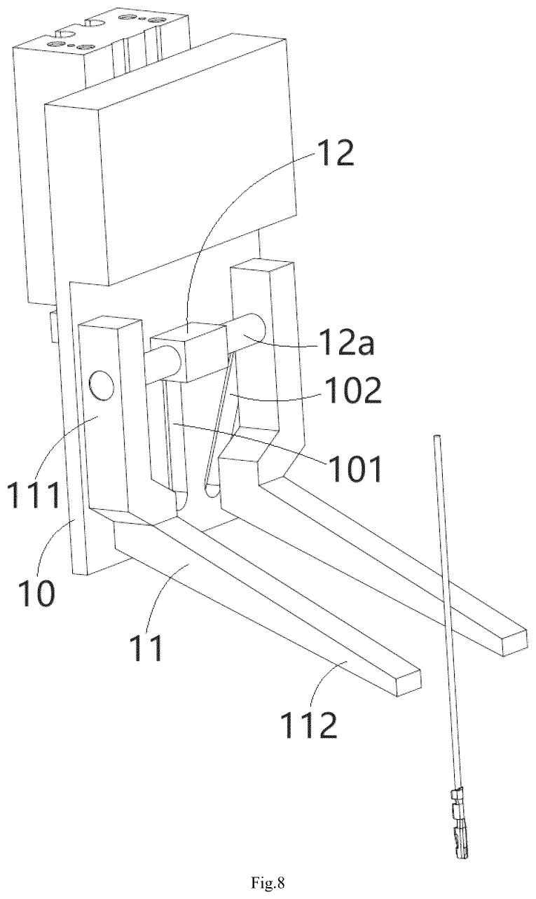

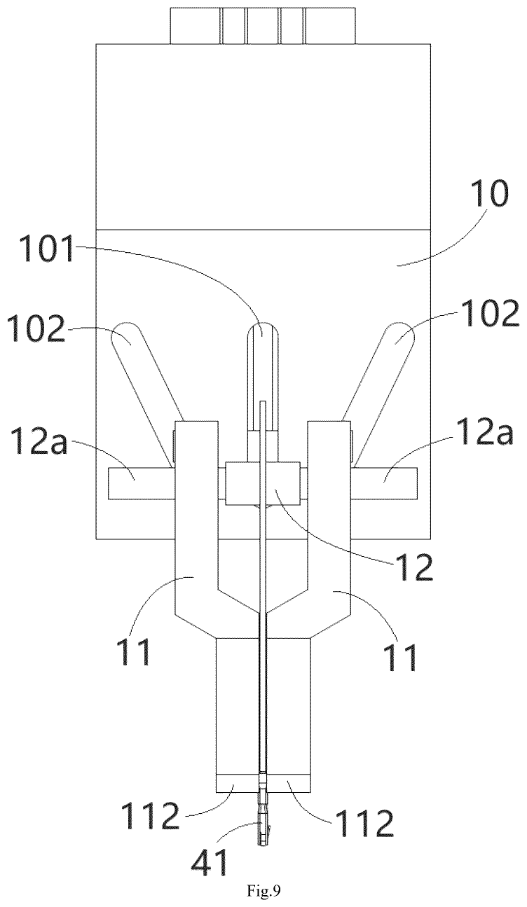

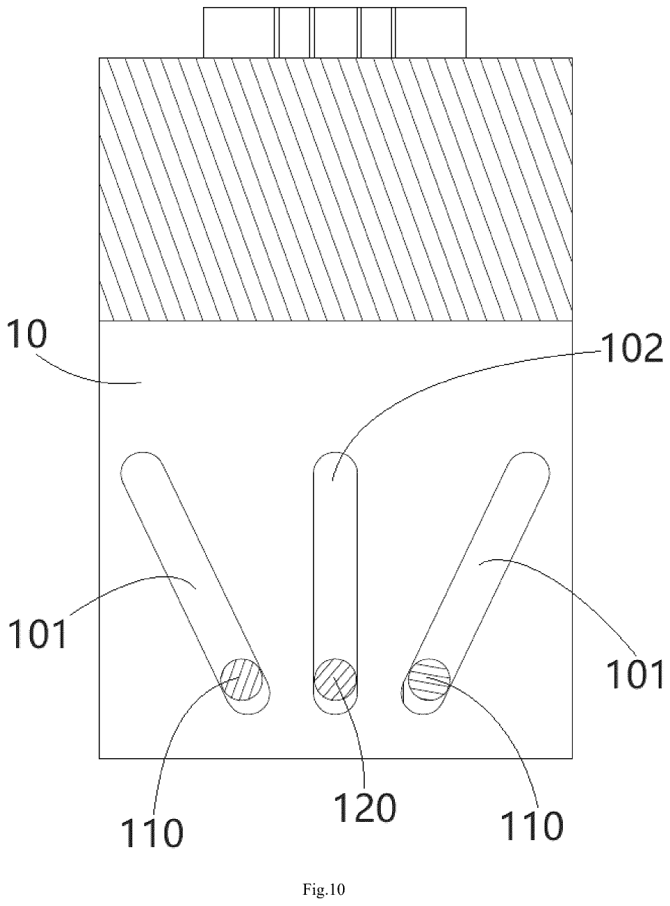

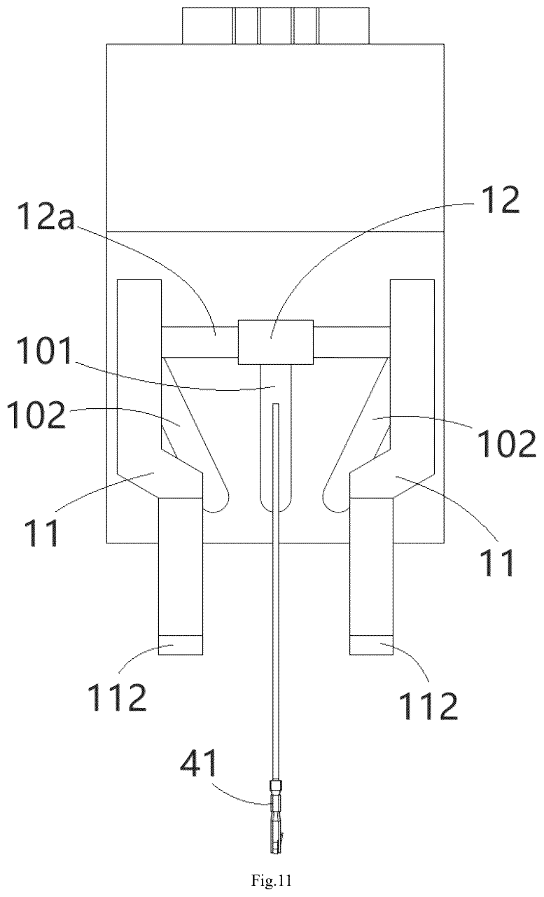

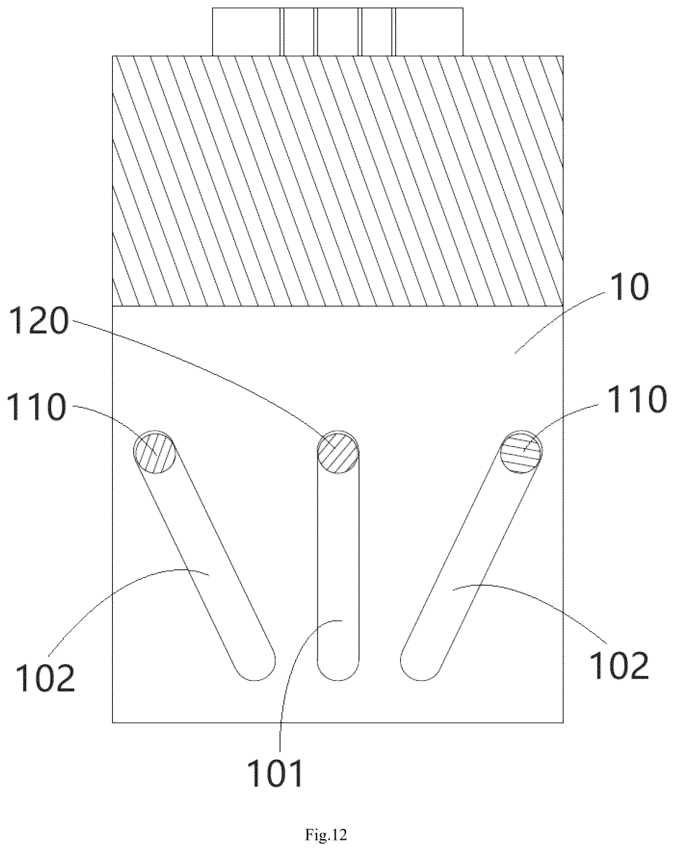

FIG. 1 shows an illustrative perspective view of a grasping device according to an exemplary embodiment of the present invention, wherein the first gripper 1 is in a closed state. FIG. 2 shows an illustrative perspective view of a grasping device according to an exemplary embodiment of the present invention, wherein the first gripper 1 is in an open state. FIG. 3 shows an illustrative exploded view of a grasping device according to an exemplary embodiment of the present invention, where the first gripper 1 is in a closed state. FIG. 4 shows an illustrative perspective view of the first gripper 1 of the grasping device according to an exemplary embodiment of the present invention when viewed from the front side, where the first gripper 1 is in a closed state. FIG. 5 shows an illustrative exploded view of the first gripper 1 of the grasping device according to an exemplary embodiment of the present invention. FIG. 6 shows an illustrative perspective view of the first gripper 1 of the grasping device according to an exemplary embodiment of the present invention when viewed from the rear, where the first gripper 1 is in a closed state. FIG. 7 shows a horizontal sectional view of the first gripper 1 of the grasping device according to an exemplary embodiment of the present invention. FIG. 8 shows an illustrative perspective view of the first gripper 1 of the grasping device according to an exemplary embodiment of the present invention when viewed from the front side, where the first gripper 1 is in an open state. FIG. 9 shows an illustrative plan view of the first gripper 1 of the grasping device according to an exemplary embodiment of the present invention, where the first gripper 1 is in a closed state. FIG. 10 shows a vertical sectional view of the first gripper 1 of the grasping device according to an exemplary embodiment of the present invention, where the first gripper 1 is in a closed state. FIG. 11 shows an illustrative plan view of the first gripper 1 of the grasping device according to an exemplary embodiment of the present invention, where the first gripper 1 is in an open state. FIG. 12 shows a vertical sectional view of the first gripper 1 of the grasping device according to an exemplary embodiment of the present invention, where the first gripper 1 is in an open state.

As shown in FIGS. 1-12, in an exemplary embodiment of the present invention, a grasping device is disclosed. The grasping device comprises a first gripper 1 for grasping a first component (e.g. a terminal 41). The first gripper 1 includes a mounting plate 10, a moving part 12, and a pair of first claws 11. The mounting plate 10 is formed with a vertical groove 101 extending in the vertical direction and a pair of inclined grooves 102 symmetrically arranged at both sides of the vertical groove 101. The moving part 12 is in slidably engaged with the vertical groove 101 to be able to move along the vertical groove 101. The pair of first claws 11 are respectively slidably engaged with the pair of inclined grooves 102, so as to be able to move along the pair of inclined grooves 102.

The pair of inclined grooves 102 form a trumpet shape that flared upwards. The moving part 12 includes a guide shaft 12a extending in a horizontal direction, and guide holes 11a are formed in the pair of first claws 11. The guide holes 11a are slidably fitted with the guide shaft 12a. When the moving part 12 is moved from bottom to top along the vertical groove 101, the pair of first claws 11 are driven by the moving part 12 to move obliquely upward along the pair of inclined grooves 102 and move along the guide shaft 12a from the closed state of gripping the first component (shown in FIG. 1) to the open state of releasing the first component (shown in FIG. 2).

The grasping device further comprises a first driver 13, which is mounted on the mounting plate 10 and connected to the moving part 12. The first driver 13 is used to drive the moving part 12 to move along the vertical groove 101, so as to drive the pair of first claws 11 to move between the closed and open states through the moving part 12.

The moving part 12 further comprises a front block 121 and an installation shaft 120. The front block 121 is located on the front side of the mounting plate 10 and is connected to the guide shaft 12a. The installation shaft 120 is connected to the front block 121. The installation shaft 120 is slidably engaged with the vertical groove 101, allowing the moving part 12 to move along the vertical groove 101.

The moving part 12 further includes a rear block 122, which is located on the rear side of the mounting plate 10. The installation shaft 120 passes through the vertical groove 101 and is connected between the front block 121 and the rear block 122. The first driver 13 is mounted on the rear side of the mounting plate 10 and connected to the rear block 122 of the moving part 12.

The first claw 11 has a connecting end 111, on which a shaft portion 110 is formed. The shaft portion 110 is slidably engaged with the inclined groove 102, allowing the first claw 11 to move along the inclined groove 102. The pair of first claws 11 are located on the front side of the mounting plate 10, and the connecting ends 111 of the pair of first claws 11 are respectively located at both sides of the front block 121 of the moving part 12, and guide holes 11a are formed in the connecting ends 111.

When the installation shaft 120 is moved to the lower end of the vertical groove 101, the shaft portion 110 is moved to the lower end of the inclined groove 102, and the pair of first claws 11 are moved to the closed state. When the installation shaft 120 is moved to the upper end of the vertical groove 101, the shaft portion 110 is moved to the upper end of the inclined groove 102, and the pair of first claws 11 are moved to the open state.

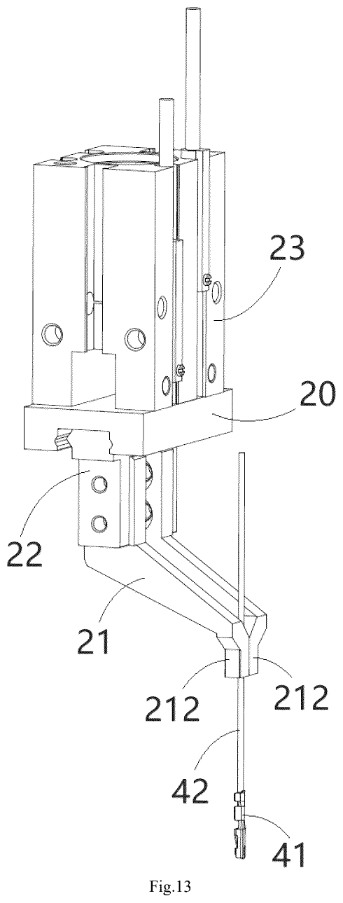

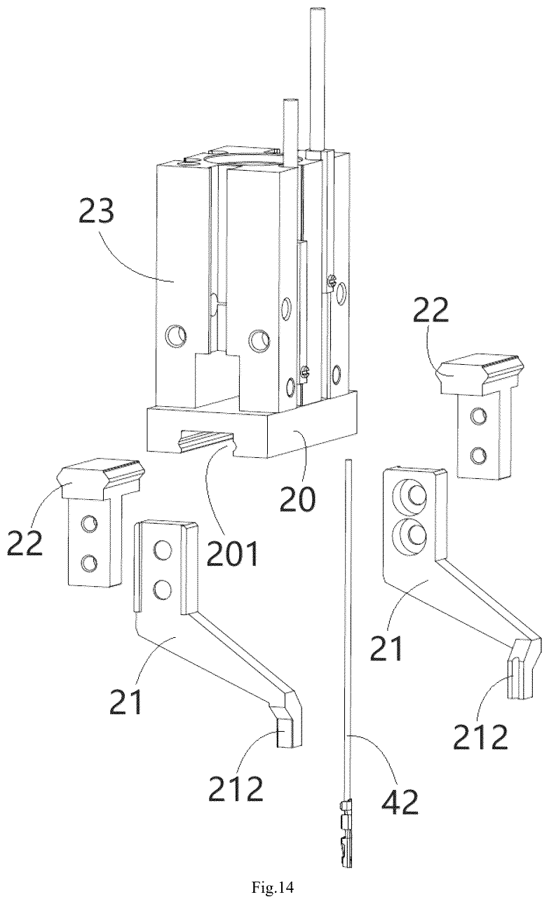

FIG. 13 shows an illustrative perspective view of the second gripper 2 of the grasping device according to an exemplary embodiment of the present invention, wherein the second gripper 2 is in a closed position. FIG. 14 shows an illustrative exploded view of the second gripper 2 of the grasping device according to an exemplary embodiment of the present invention.

As shown in FIGS. 1-14, in the illustrated embodiment, the grasping device further comprises a second gripper 2, which is used to grip a second component connected to the first component (e.g., a cable 42 connected to the terminal 41). The second gripper 2 includes an installation block 20, a pair of second claws 21, and a second driver 23. The installation block 20 is formed with a slot 201. The pair of second claws 21 are slidably engaged with the slot 201 of the installation block 20, and can be moved between a closed position of clamping the second component and an open position of releasing the second component. The second driver 23 is installed on the installation block 20 and connected to the pair of second claws 21. The second driver 23 is used to drive the pair of second claws 21 to move between closed and open positions to clamp or release the second component. The slot 201 on the installation block 20 is parallel to the guide shaft 12a on the moving part 12 to guide the pair of second claws 21 to move horizontally. The second gripper 2 also includes a pair of sliders 22, which are slidably installed in the sliding slot 201. The pair of second claws 21 are respectively connected to the pair of sliders 22.

The pair of first claws 11 have a pair of first gripping ends 112 for gripping the first component, and the pair of second claws 21 have a pair of second gripping ends 212 for gripping the second component. When the pair of first gripping ends 112 are moved to the closed state, the pair of first gripping ends 112 are located directly below the pair of second gripping ends 212 and are spaced a predetermined distance apart from the pair of second gripping ends 212 in the vertical direction. When the pair of first gripping ends 112 are moved to the open state, the pair of second gripping ends 212 are located between the pair of first gripping ends 112 and adjacent to them in the vertical direction.

The grasping device further comprises a fixed block 30 and a flange 3. The mounting plate 10 of the first gripper 1 and the second driver 23 of the second gripper 2 are respectively fixed to the front and rear sides of the fixed block 30. The flange 3 is fixed to the top side of the fixed block 30 and is suitable for connecting with various moving mechanisms, such as robots, translation mechanisms, or servo moving mechanisms.

In the exemplary embodiment, the first component is a terminal 41. The second component is a cable 42 connected to one end of the terminal 41. The pair of first clamps 11 are used to clamp one end of the terminal 41, and the pair of second clamps 21 are used to clamp the cable 42.

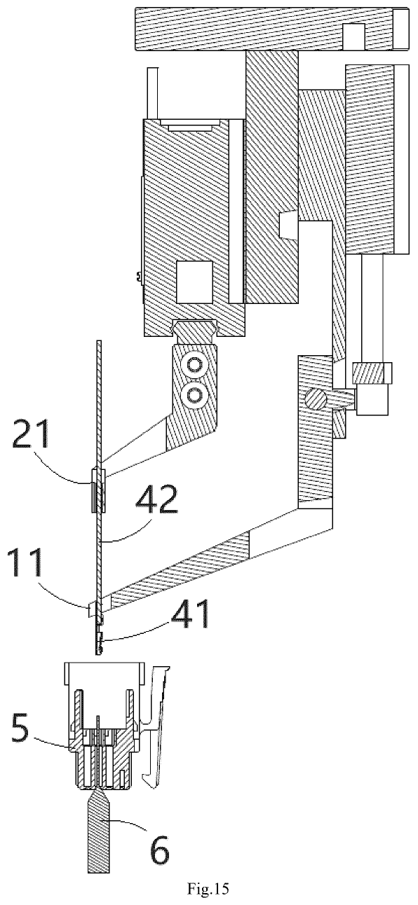

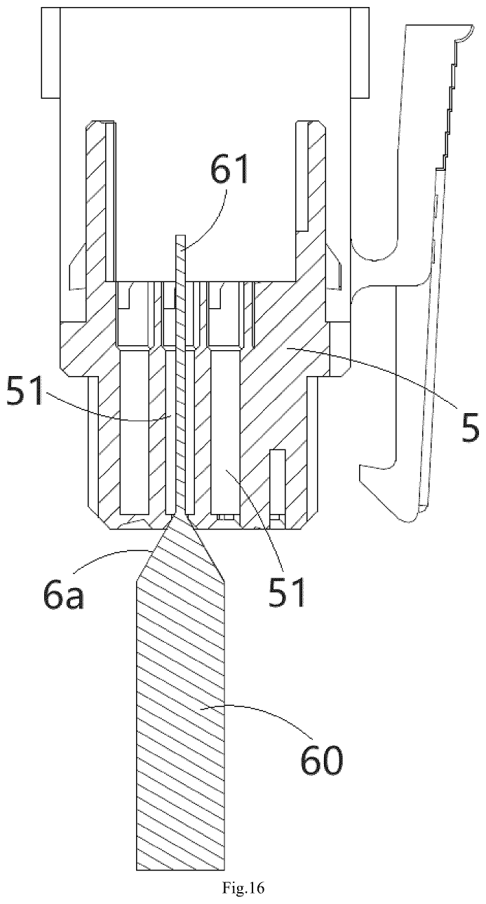

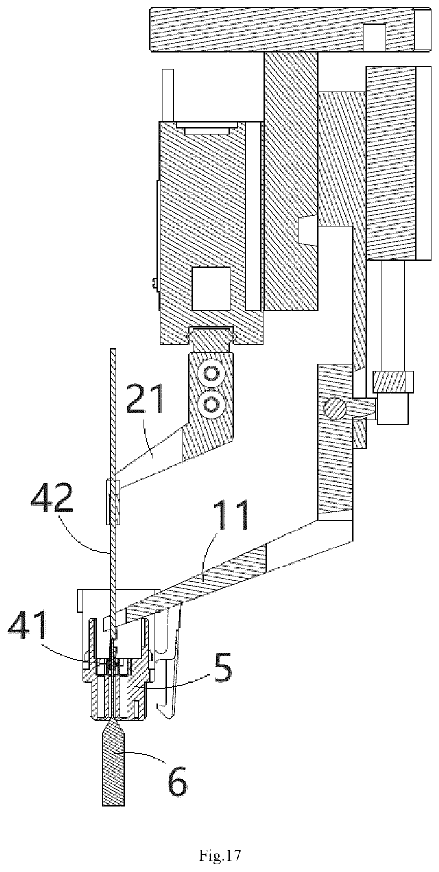

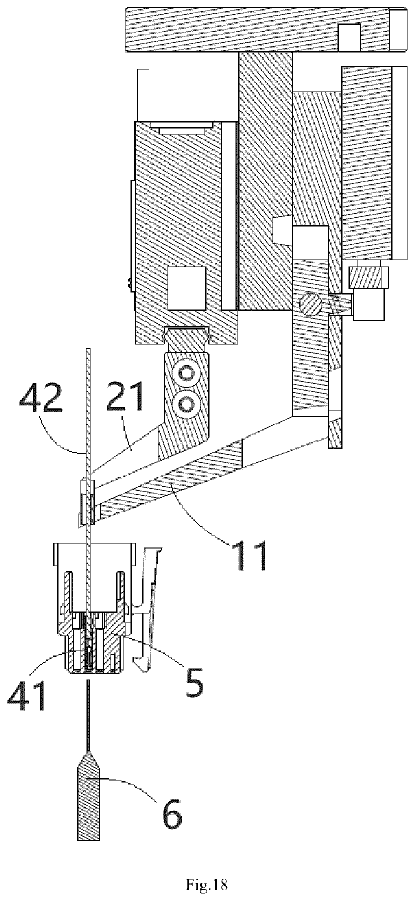

FIG. 15 shows an illustrative view of a terminal insertion device according to an exemplary embodiment of the present invention, where terminal 41 has not yet been inserted into socket 51 of housing 5. FIG. 16 shows an illustrative enlarged view of the housing 5 and guide component 6 shown in FIG. 15. FIG. 17 shows an illustrative view of a terminal insertion device according to an exemplary embodiment of the present invention, in which the front end of terminal 41 has been inserted into socket 51 of housing 5. FIG. 18 shows an illustrative view of a terminal insertion device according to an exemplary embodiment of the present invention, in which terminal 41 and cable 42 have been inserted into socket 51 of housing 5.

As shown in FIGS. 1-18, in another exemplary embodiment of the present invention, a terminal insertion device is also disclosed. The terminal insertion device includes the aforementioned grasping device and a moving mechanism. The first gripper 1 and the second gripper 2 of the grasping device are used to respectively grasp the terminal 41 and the cable 42 connected to the terminal 41. The moving mechanism is connected to the grasping device and is used to move the grasping device in a predetermined direction to insert the grasped terminal 41 and cable 42 into a socket 51 of a housing 5.

When the front end of the terminal 41 is inserted into the socket 51 of the housing 5, the first driver 13 drives the pair of first claws 11 to move from the closed state to the open state, in order to release the terminal 41 clamped by the pair of first claws 11 and move the pair of first claws 11 to the avoidance position that does not interfere with the housing 5. When both the terminal 41 and the cable 42 have been inserted into the socket 51 of the housing 5, the second driver 23 drives the pair of second claws 21 to move from the closed position to the open position to release the cable 42 clamped by the pair of second claws 21.

The terminal insertion device further comprises a guide component 6, which passes through the socket 51 of the housing 5 and is adapted to mate with the front end of the terminal 41, for guiding the front end of the terminal 41 to be inserted into the inlet of the socket 51 of the housing 5. The guide component 6 includes a positioning body 60 and a guide pin 61. The positioning body 60 is positioned into the outlet of the socket 51 of the housing 5. The guide pin 61 is connected to the positioning body 60 and passes through the socket 51 of the housing 5. The end of guide pin 61 is suitable for mating with the front end of the terminal 41, used to guide the front end of terminal 41 into the inlet of socket 51. The positioning body 60 has a conical positioning portion 6a, which is positioned in the outlet of the socket 51, so that the guide pin 61 is centrally positioned in the socket 51. After the front end of the terminal 41 is inserted into the socket 51 of the housing 5, the guide component 6 is pulled out of the socket 51 of the housing 5 to allow the terminal 41 to be further inserted into the socket 51.

As shown in FIGS. 1-18, in another exemplary embodiment of the present invention, a gripper 1 is also disclosed. The gripper 1 includes a mounting plate 10, a moving part 12, and a pair of claws 11. The mounting plate 10 is formed with a vertical groove 101 extending in a vertical direction and the pair of inclined grooves 102 symmetrically arranged at both sides of the vertical groove 101. The moving part 12 is slidably engaged with the vertical groove 101 to be able to move along the vertical groove 101. The pair of claws 11 are respectively slidably engaged with the pair of inclined grooves 102, so as to be able to move along the pair of inclined grooves 102. The pair of inclined grooves 102 form a trumpet shape that flared upwards. The moving part 12 includes a guide shaft 12a that extends in a horizontal direction, and guide holes 11a that are slidably fitted with the guide shaft 12a are formed in the pair of claws 11. When the moving part 12 is moved from bottom to top along the vertical groove 101, the pair of claws 11 are driven by the moving part 12 to move obliquely upward along the pair of inclined grooves 102 and move along the guide shaft 12a from the closed state to the open state.

The gripper 1 further includes a driver 13, which is mounted on the mounting plate 10 and connected to the moving part 12. The driver 13 is used to drive the moving part 12 to move along the vertical groove 101, so as to drive the pair of claws 11 to move between closed and open states through the moving part 12.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A grasping device, comprising:
a first gripper adapted to grip a first component, including:
a mounting plate formed with a vertical groove extending in a vertical direction and a pair of inclined grooves symmetrically arranged on both sides of the vertical groove, the pair of inclined grooves forming a trumpet shape that flared upwards;
a moving part comprising a guide shaft extending in a horizontal direction and slidably engaged with the vertical groove to be able to move along the vertical groove; and
a pair of first claws respectively slidably engaged with the pair of inclined grooves to be able to move along the pair of inclined grooves respectively, wherein:
guide holes that are slidably fitted with the guide shaft are respectively formed in the pair of first claws; and
when the moving part is moved from bottom to top along the vertical groove, the pair of first claws are driven by the moving part to move obliquely upward along the pair of inclined grooves and move along the guide shaft from a closed state of clamping the first component to an open state of releasing the first component.

2. The grasping device according to claim 1, further comprising a first driver which is installed on the mounting plate and connected to the moving part, wherein the first driver is used to drive the moving part to move along the vertical groove, so as to drive the pair of first claws to move between the closed state and the open state through the moving part.

3. The grasping device according to claim 2, wherein the moving part further comprises:
a front block located on the front side of the mounting plate and connected to the guide shaft; and
an installation shaft connected to the front block, wherein the installation shaft is in slidably engaged with the vertical groove, allowing the moving part to move along the vertical groove.

4. The grasping device according to claim 3, wherein:
the moving part further comprises a rear block which is located on the rear side of the mounting plate, wherein the installation shaft passes through the vertical groove and is connected between the front block and the rear block; and
the first driver is installed on the rear side of the mounting plate and connected to the rear block of the moving part.

5. The grasping device according to claim 3, wherein the first claw has a connecting end, and a shaft portion is formed on the connecting end; the shaft portion is slidably engaged with the inclined groove, allowing the first claw to move along the inclined groove.

6. The grasping device according to claim 5, wherein the pair of first claws are located on the front side of the mounting plate, and the connecting ends of the pair of first claws are respectively located at both sides of the front block of the moving part, and the guide holes are formed in the connecting ends.

7. The grasping device according to claim 5, wherein:
when the installation shaft is moved to the lower end of the vertical groove, the shaft portion is moved to the lower end of the inclined groove, and the pair of first claws are moved to the closed state; and
when the installation shaft is moved to the upper end of the vertical groove, the shaft portion is moved to the upper end of the inclined groove, and the pair of first claws are moved to the open state.

8. The grasping device according to claim 1, further comprising a second gripper for gripping a second component connected to the first component, the second gripper comprising:
an installation block formed with a slot;
a pair of second claws that are slidably engaged with the slot of the installation block and can be moved between a closed position and an open position; and
a second driver which is installed on the installation block and connected to the pair of second claws, wherein the second driver is used to drive the pair of second claws to move between the closed position and the open position to clamp or release the second component.

9. The grasping device according to claim 8, wherein:
the slot on the installation block is parallel to the guide shaft on the moving part to guide the pair of second claws to move in the horizontal direction; and
the second gripper further comprises a pair of sliders which are respectively slidably installed into the slot, wherein the pair of second claws are respectively connected to the pair of sliders.

10. The grasping device according to claim 8, wherein:
the pair of first claws have a pair of first gripping ends for gripping the first component, and the pair of second claws have a pair of second gripping ends for gripping the second component;
when the pair of first gripping ends are moved to the closed state, the pair of first gripping ends are located directly below the pair of second gripping ends and are at a predetermined distance from the pair of second gripping ends in the vertical direction; and
when the pair of first gripping ends are moved to the open state, the pair of second gripping ends are located between the pair of first gripping ends and adjacent to the pair of first gripping ends in the vertical direction.

11. The grasping device according to claim 8, further comprising:
a fixed block, wherein the mounting plate of the first gripper and the second driver of the second gripper are respectively fixed to the front and rear sides of the fixed block; and
a flange fixed to the top side of the fixed block and is suitable for connecting with various moving mechanisms.

12. The grasping device according to claim 8, wherein the first component is a terminal, and the second component is a cable connected to one end of the terminal, the pair of first claws are used to grip one end of the terminal, and the pair of second claws are used to clamp the cable.

13. A terminal insertion device, comprising:
the grasping device according to claim 1, wherein the first gripper and the second gripper are used to respectively grip the terminal and the cable connected to the terminal; and
a moving mechanism which is connected to the grasping device and is used to move the grasping device in a predetermined direction to insert the gripped terminal and cable into a socket of a housing.

14. The terminal insertion device according to claim 13, wherein:
when the front end of the terminal is inserted into the socket of the housing, the first driver drives the pair of first claws to move from the closed state to the open state, in order to release the terminal clamped by the pair of first claws and move the pair of first claws to an avoidance position that does not interfere with the housing; and
when both the terminal and the cable have been inserted into the socket of the housing, the second driver drives the pair of second claws to move from the closed position to the open position to release the cable clamped by the pair of second claws.

15. The terminal insertion device according to claim 14, further comprising a guide component which passes through the socket of the housing and is adapted to mate with the front end of the terminal, for guiding the front end of the terminal to be inserted into the inlet of the socket of the housing.

16. The terminal insertion device according to claim 15, wherein the guide component comprises:
a positioning body positioned into the outlet of the socket of the housing; and
a guide pin connected to the positioning body and passing through the socket of the housing, wherein the end of the guide pin is adapted to mate with the front end of the terminal, for guiding the front end of the terminal to be inserted into the inlet of the socket.

17. The terminal insertion device according to claim 16, wherein the positioning body has a conical positioning portion, which is positioned in the outlet of the socket, so that the guide pin is centrally positioned in the socket.

18. The terminal insertion device according to claim 15, wherein after the front end of the terminal is inserted into the socket of the housing, the guide component is pulled out from the socket of the housing to allow the terminal to be further inserted into the socket.

19. A gripper, comprising:
a mounting plate formed with a vertical groove extending in a vertical direction and a pair of inclined grooves symmetrically arranged at both sides of the vertical groove;
a moving part slidably engaged with the vertical groove to be able to move along the vertical groove; and
a pair of claws respectively slidably engaged with the pair of inclined grooves to be able to move along the pair of inclined grooves respectively, wherein:
the pair of inclined grooves form a trumpet shape that flared upwards, and the moving part comprises a guide shaft extending in a horizontal direction; guide holes that are slidably fitted with the guide shaft are respectively formed in the pair of claws; and
when the moving part is moved from bottom to top along the vertical groove, the pair of claws are driven by the moving part to move obliquely upward along the pair of inclined grooves and move along the guide shaft from a closed state of clamping the first component to an open state of releasing the first component.

20. The gripper according to claim 19, further comprising a driver installed on the mounting plate and connected to the moving part, wherein the driver is used to drive the moving part to move along the vertical groove, so as to drive the pair of claws to move between the closed state and the open state through the moving part.
